(19) United States
(12) Patent Application Publication
(10) Pub. No.: US 2002/0124029 A1
(43) Pub. Date: Sep. 5, 2002

(54) Method and apparatus for creating, embedding and using a searchable font

(76) Inventors: John Glen Gwinn, San Diego, CA (US); Lisa Yvette Gutierrez, San Diego, CA (US)

Correspondence Address: Alex C. Chen, SKJERVEN MORRILL MacPHERSON LLP, Suite 700, 25 Metro Drive, San Jose, CA, 95110-1349, US

(21) Appl. No.: 09/798,537

(22) Filed: Mar. 2, 2001

(51) Int. Cl. G06F 17/21

(52) U.S. Cl. 707/542

(57) ABSTRACT

Methods of creating, embedding and using a searchable font are provided. One method comprises accessing a schematic using a first software operating at a first computer. The method further comprises embedding a mono-spaced font into line art text in the schematic and electronically converting the schematic into a Portable Document Format file. The mono-spaced font in the Portable Document Format file is configured to be electronically searchable by users using a second software.

### BACKGROUND OF THE INVENTION

1. Field of the Invention

The present invention relates to manipulating data files, and more particularly to creating, embedding and using a searchable font in a data file.

2. Description of the Related Art

The text in conventional computer-generated schematics is called ‘line art’ and cannot be highlighted, selected or changed by users with a viewing software, such as Adobe Acrobat Reader. In addition, textual searches with software, such as Adobe Acrobat Reader, do not recognize the line art text as searchable text.

Service technicians use printed manuals with schematics to repair and service products, such as TVs, computers and DVD players. The service personnel typically spend a lot of time trying to find individual components, their part numbers and characteristics in the schematics. In addition, engineering changes are not easily updated in printed manuals that are being used by service personnel in the field.

### SUMMARY OF THE INVENTION

Methods and apparatuses for creating, embedding and using a searchable font in data files are provided in accordance with the present invention. The searchable font may be embedded in textual line art in documents and schematics, such as component diagrams, circuit diagrams, printed wiring board (PWB) diagrams, signal timing diagrams, engineering diagrams, assembly diagrams, manufacturing drawings, graphics, photographs, images, charts, tables, lists and other figures. The searchable font has special characteristics that allow users to initiate software text searches for the searchable font embedded in a schematic. The schematics may be incorporated into service manuals for devices such as cameras, TVs, computers, DSS and WebTV products, VCRs, DVD players, stereo systems, receivers, camcorders, audio/visual equipment, printers, copiers and other mechanical or electrical devices.

One advantage of the specialized searchable font is allowing users, such as engineers, technicians and service personnel, to electronically search and instantly find embedded text in schematics. Conventional line art text in schematics is not accessible to textual searches with software, such as Adobe Acrobat Reader. The searchable font is particularly useful in complex schematics with a large number of parts or circuit components. Typically, a schematic is created by an engineer with a computer-aided design (CAD) software at one computer, and service personnel access the schematic with a more accessible software, such as Adobe Acrobat Reader, at other computers.

Another advantage of the specialized searchable font is allowing users to quickly cross-reference text in one schematic on a computer screen with text in other schematics. The cross-referencing feature is particularly useful if there are several schematics spread throughout a document, such as a service manual, and each schematic has a large number of components. For example, users may spend a lot of time manually searching for a particular component, such as a resistor, in (1) a general circuit diagram, (2) a printed wiring board (PWB) diagram showing the physical location of the components, and (3) a list of components with manufacturer part numbers. Moreover, users may have to repeatedly zoom in and zoom out of large schematics to see particular components and how they function with other components. The searchable font allows users to quickly search and perform cost effective repairs (trouble-shooting) and service to products.

Another advantage of the specialized searchable font is allowing service manuals with schematics to be digitally distributed, e.g., via CD-ROM, Internet or Ethernet, to a large number of service personnel at various locations around the world. With readable, searchable font in soft copy schematics, users no longer have to print pages of schematics. Thus, the soft copy schematics reduce printing costs. In addition, engineers can easily change, update and distribute schematics with searchable font to all service personnel.

One aspect of the invention relates to a method of using a searchable font. The method comprises accessing a schematic with line art text using a first software operating at a first computer. The method further comprises embedding a mono-spaced font into the line art text in the schematic and electronically converting the schematic into a Portable Document Format file. The mono-spaced font in the Portable Document Format file is configured to be electronically searchable by users using a second software.

Another aspect of the invention relates to a system for embedding a searchable font. The system comprises a first software and a second software operating at a first computer. The first software is configured to create a schematic with line art text. The second software is configured to electronically convert the schematic into a Portable Document Format file and embed a mono-spaced font into the line art text in the schematic. The mono-spaced font in the schematic is configured to be electronically searchable by at least one user.

### BRIEF DESCRIPTION OF THE DRAWINGS

FIG. 1A illustrates an example of a multi-spaced font and an example of a mono-spaced font.

FIG. 1B illustrates an example of horizontal spacing of a mono-spaced font.

FIG. 1C illustrates an example of Courier font, which is a mono-spaced font.

FIG. 2 illustrates one embodiment of a mono-spaced, embeddable, searchable font in accordance with the present invention.

FIG. 3 illustrates an exemplifying circuit schematic created by a user using a CAD software and converted into a PDF format by Adobe Distiller.

FIGS. 4A-4C illustrate the exemplifying circuit schematic in FIG. 3 after a user embeds various fonts in the schematics with software, such as ICAD and Adobe Distiller.

FIG. 5 illustrates the circuit schematic of FIG. 3 with the searchable font of FIG. 2 embedded by software, such as ICAD and Adobe Distiller.

FIG. 6 illustrates one embodiment of a method for embedding a searchable font, such as the searchable font of FIG. 2, into a previously prepared schematic.

FIGS. 7A-7J illustrate an example of embedding a searchable font into a prepared schematic.

FIGS. 8A-8D illustrate exemplifying configurable settings for a printer driver to configure a PostScript file with embedded searchable font for printing.

FIGS. 9A-9E illustrate exemplifying configurable settings for a printer driver to configure a PostScript file with embedded searchable font for on-screen viewing.

FIGS. 10A-10D illustrate exemplifying PDF schematics that may be included in a document, such as a service manual for a device.

FIGS. 11A-11B illustrate exemplifying lists of parts in FIGS. 10A-10D.

FIGS. 12A-12C illustrate an example of using a searchable font in the schematics of FIGS. 10A-10D.

### DETAILED DESCRIPTION

A user may create a schematic with a computer-aided design (CAD) software, such as Integrated Computer Aided Design (ICAD) made by Fujitsu. The term ‘schematic’ as used herein includes any data file generated or altered by a computer, such as, for example, component diagrams, circuit diagrams, printed wiring board (PWB) diagrams, signal timing diagrams, engineering diagrams, assembly diagrams, manufacturing drawings, graphics, photographs, images, charts, tables, lists and other figures. The schematic often has ‘line art’ text, which is inserted when the schematic is created and is considered a part of the schematic. In some CAD programs, such as ICAD, the size, spacing and style of line art text in the schematic cannot be altered by a user.

After creating the schematic, the user may convert the schematic into a Portable Document Format (PDF) file with software, such as Adobe Distiller. The converted PDF schematic may be opened with Adobe Acrobat Reader. When a user searches for text in the converted PDF schematic with software such as Adobe Acrobat Reader, the software will not recognize line art text.

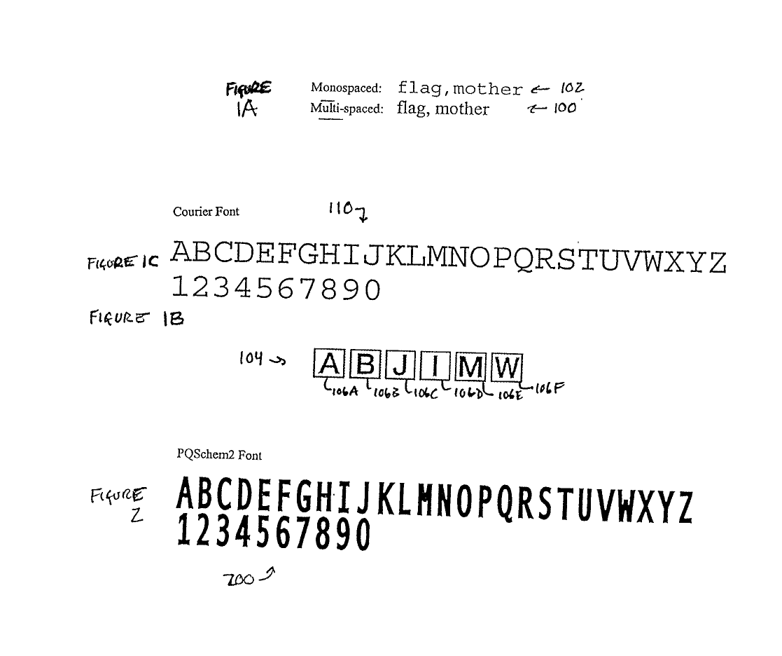

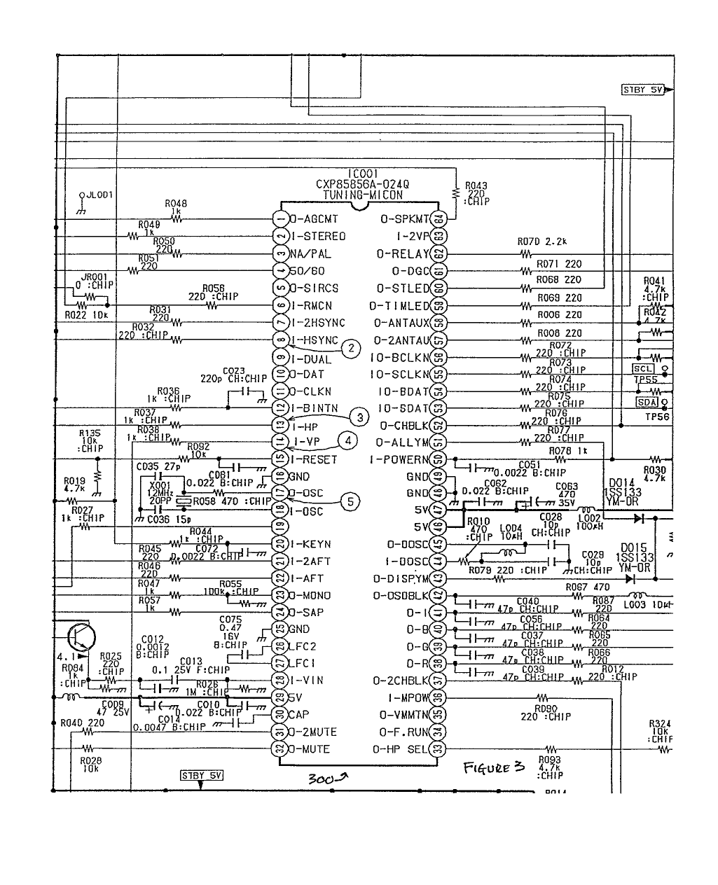

FIG. 1A illustrates the difference between an exemplifying multi-spaced font 100 (also called non-mono-spaced font or multi-width font) and an exemplifying mono-spaced font 102. In multi-spaced fonts, the width or horizontal space that each character occupies (both text and assigned white space) may be vary from character to character when typed, depending on the width of the character itself. For example, in the multi-spaced font 100, the letters ‘f,’ ‘l’ and ‘t’ occupy less horizontal space, i.e., have a different width, than the letters ‘a,’ ‘g,’ ‘o,’ ‘e’ and ‘r.’ The multi-spaced font 100 compensates for letter differences to conserve space and improve legibility. Most conventional fonts are multi-spaced fonts.

If line art text in schematics created by a CAD software is embedded with multi-spaced font, software such as Adobe Acrobat Reader will treat some of the embedded multi-spaced font as separate words. For example, if a line art word ‘flag’ in a schematic is embedded with a multi-spaced font, and the schematic is converted to a PDF file, software such as Adobe Acrobat Reader will not be able to find the word ‘flag.’ Instead, the software will read ‘fl’ and ‘ag’ as two separate words, and the search for the word ‘flag’ will be unsuccessful.

FIG. 1B illustrates an example of horizontal spacings 106A-106F of a mono-spaced font 104. In contrast to multi-spaced fonts (FIG. 1A), each character in a mono-spaced font 104, occupies the same amount of horizontal space or width 106 as other characters when typed, regardless of the actual width of the character itself. In FIG. 1B, the horizontal space or width 106 of each character is denoted as an imaginary box around each character. As a result, narrow characters like ‘I,’ ‘l,’ ‘.’ and ‘!’ occupy the same horizontal spaces as wide characters such as ‘M’ and ‘W.’

FIG. 1C illustrates an example of Courier font 110, which is a mono-spaced font. In contrast to multi-spaced fonts, text embedded with mono-spaced fonts, such as the Courier font 110 in FIG. 1C, in a schematic is searchable with software such as Adobe Acrobat Reader. Embedded Courier font 110 in FIG. 1C and other embedded mono-spaced fonts may be used by the methods described below in accordance with the present invention. Some mono-spaced fonts are difficult to read, especially when the mono-spaced fonts are used in large blocks of text or in compressed schematics.

Creating a Searchable Font

The present inventors experimented with fonts of various heights, widths, spacing and weights to improve on-screen legibility and printed legibility in various schematics. The inventors also tested the fonts' searchability, search accuracy, and compatibility with various types of software, such as ICAD, printer drivers and Adobe Distiller.

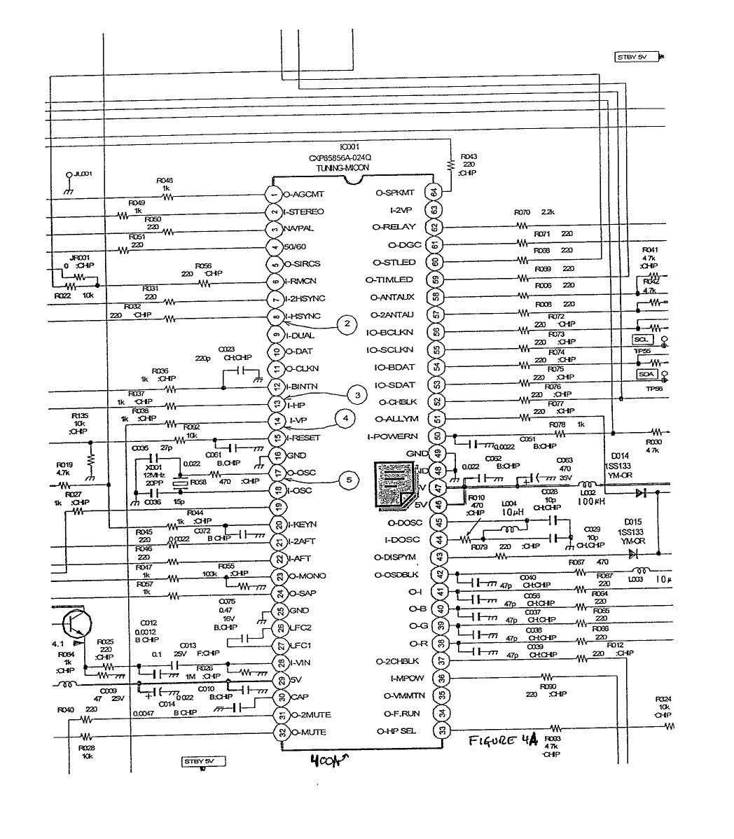

FIG. 2 illustrates one embodiment of a mono-spaced, embeddable, searchable font 200 in accordance with the present invention. The searchable font 200 in FIG. 2 was created by the inventors with Fontographer, a software developed by Macromedia of San Francisco, Calif. In one embodiment, the searchable font 200 is compatible with various types of software, such as ICAD, Adobe Distiller, Adobe Acrobat Reader, Microsoft Word and Microsoft Excel.

The searchable font 200 in FIG. 2 is mono-spaced to enable accurate searches once the font 200 is embedded in PDF schematics. The letters of the searchable font 200 in FIG. 2 are narrower than the letters of other mono-spaced fonts, such as the Courier font 110 of FIG. 1C. In one embodiment, the aspect ratio (ratio of height to width) of the font 200 in FIG. 2 is about 2 to 1. Fonts with other aspect ratios may be used in accordance with the present invention.

The spacing between letters of the mono-spaced font 200 (FIG. 2) may also be narrower than the spacing between letters of other mono-spaced fonts, such as the Courier font 110 of FIG. 1C. Thus, the searchable font 200 in FIG. 2 uses horizontal space more efficiently than other mono-spaced fonts, such as the Courier font 110 of FIG. 1C. For example, the letters A through Z in the searchable font 200 in FIG. 2 occupies less horizontal space than the letters A through Z in Courier font 110 of FIG. 1C. The searchable font 200 in FIG. 2 could also advantageously fit into small areas or congested areas of a schematic, unlike other fonts.

The searchable font 200 in FIG. 2 is also taller and thicker than other mono-spaced fonts, such as the Courier font 110 of FIG. 1C. In one embodiment, the font 200 is bolded, and the weight of the font 200 is about three times heavier than the standard, non-bolded Courier font 110 in FIG. 1C. Thus, the searchable font 200 in FIG. 2 is more legible to users in both on-screen and printed schematics. One embodiment of the searchable font 200 is called ‘PQSCHEM’ or ‘PQSCHEM2’ (Product Quality Schematic Font, versions 1 and 2), which are shown in FIGS. 2, 5, 7B, 7F, 7G, 7I, 9C, 10A-10D and 12A-12C.

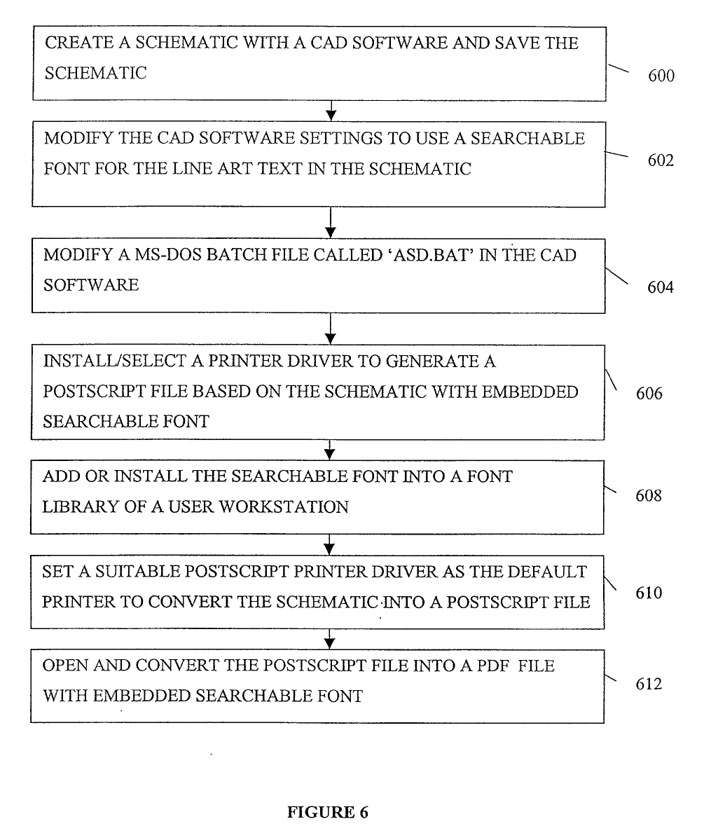

In general, a user creates a schematic containing line art text with CAD software, such as ICAD. The user directs the CAD software to use a searchable font, such as the searchable font 200 in FIG. 2, in the schematic (described in more detail below with reference to FIGS. 6-9E). The user uses a printer driver (software) to generate a PostScript file based on the schematic. The user uses a software, such as Adobe Distiller, to convert the PostScript file into a PDF file. When a converted PDF schematic is later opened with a software, such as Adobe Acrobat Reader, the searchable font 200 is searchable to users.

The searchable font 200 may be embedded in schematics for devices such as cameras, TVs, computers, DSS and WebTV products, VCRs, DVD players, stereo systems, receivers, camcorders, audio/visual equipment, printers, copiers and other mechanical or electrical devices.

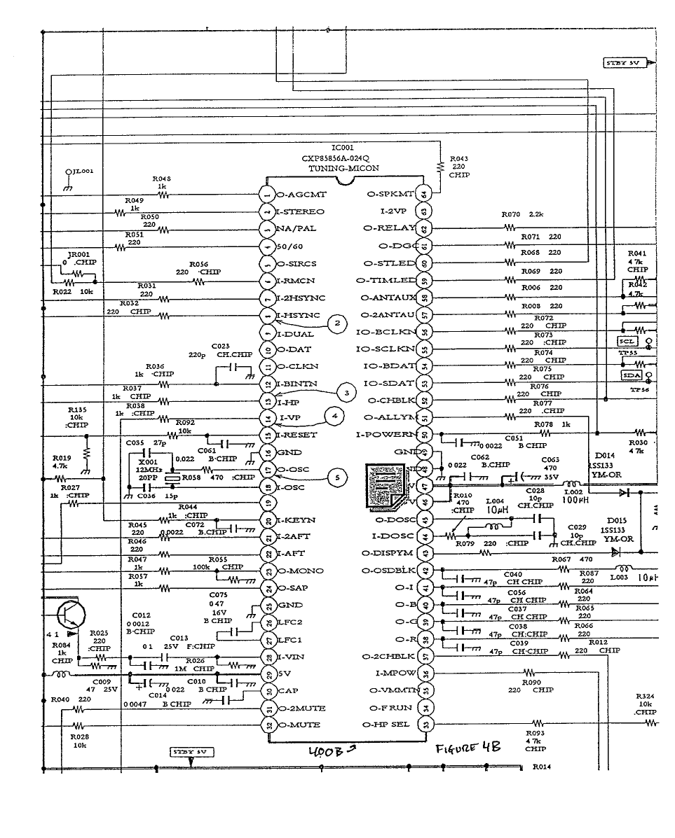

FIG. 3 illustrates an exemplifying circuit schematic 300 created by a user using a CAD software, such as ICAD, and converted into a PDF format by Adobe Distiller. In FIG. 3, a user created the schematic 300 and inserted line art text with the CAD software. There are no embedded fonts in the schematic 300 of FIG. 3. After the schematic is converted to a PDF file, the line art text cannot be accessed and is not searchable with a software such as Adobe Acrobat Reader.

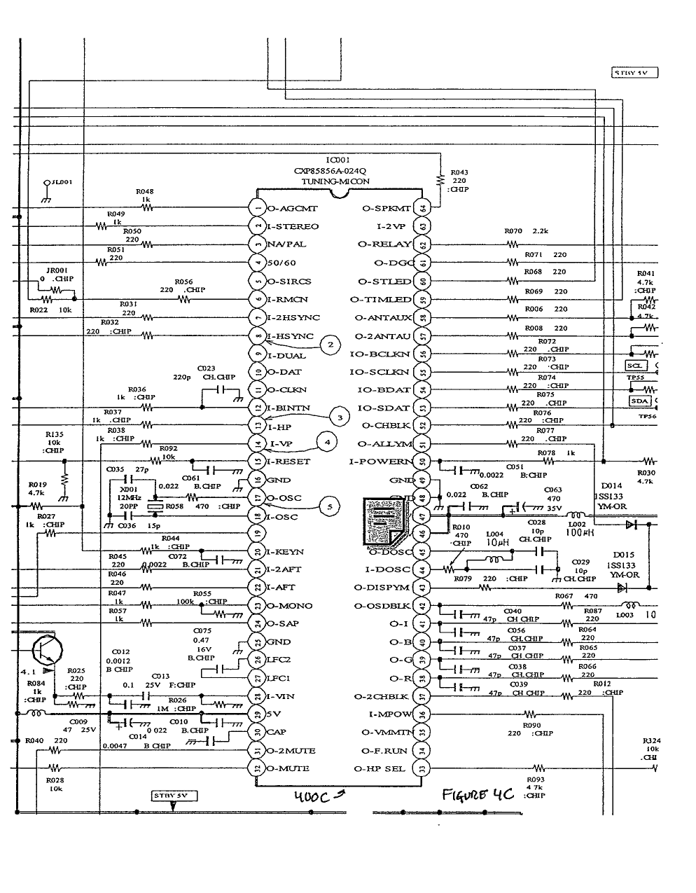

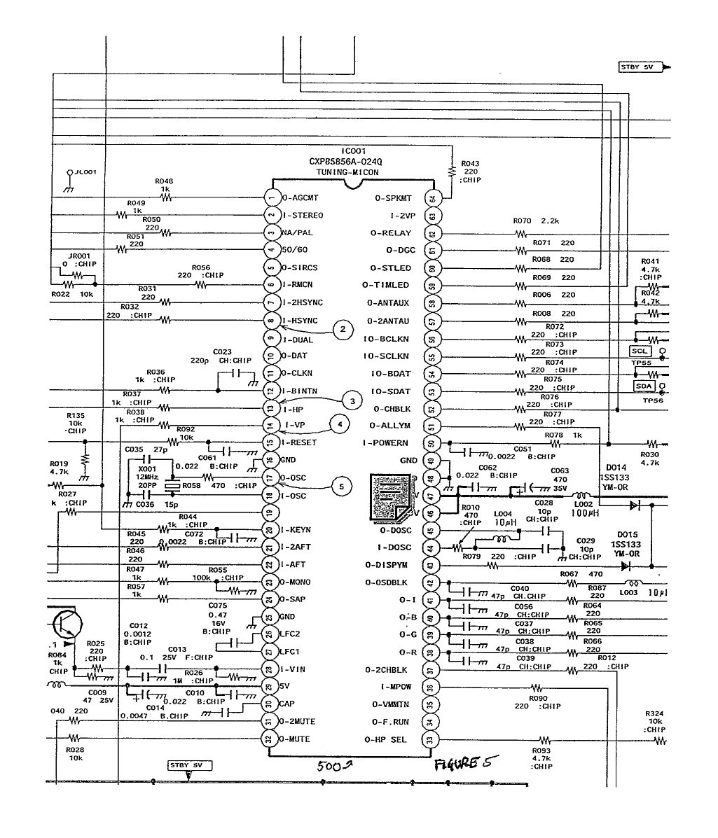

FIGS. 4A-4C illustrate the exemplifying circuit schematic 300 in FIG. 3 after a user converts the schematics 400A-400C into PDF files with Adobe Distiller and embeds various fonts in the schematics 400A-400C with software, such as ICAD, a printer driver and Adobe Distiller (described below). The schematics 400A-400C in FIGS. 4A-4C may be opened with Adobe Acrobat Reader. As a result of embedding the fonts and converting the schematics into PDF files, the spacing between the text and the components in FIGS. 4A-4C may appear shifted and disorganized. As shown in FIGS. 4A-4C, some of the embedded fonts interfere with the circuit components. For example, the text ‘GND’ overlaps pins 48 and 49 in FIGS. 4A-4C. The large widths of the embedded fonts in FIGS. 4A-4C may also cause the schematics 400A-400C to look disorganized.

FIG. 5 illustrates the circuit schematic 300 of FIG. 3 with the searchable font 200 of FIG. 2 embedded by software, such as ICAD, a printer driver and Adobe Distiller, and converted by Adobe Distiller into a PDF file. When the schematic 500 is viewed on-screen or printed with Adobe Acrobat Reader, the embedded searchable font appears more organized than the fonts in FIGS. 4A-4C. The embedded searchable font in FIG. 5 does not interfere with the circuit components. For example, the text ‘GND’ in FIG. 5 is configured with the searchable font 200 of FIG. 2 and does not overlap pins 48 and 49. In addition, the embedded searchable font in FIG. 5 is more legible than the fonts in FIGS. 4A-4C.

Embedding A Searchable Font

A searchable font, such as the font 200 of FIG. 2, may be embedded in any line art text of a computer-generated schematic. The legibility and searchability of an embedded searchable font allows schematics to be distributed via the Internet or an Ethernet to a very large number of users, such as service personnel, at various locations around the world.

FIG. 6 illustrates one embodiment of a method for embedding a searchable font, such as the searchable font 200 of FIG. 2, into a previously prepared schematic. In process block 600 of FIG. 6, a user creates a schematic with a CAD software and saves the schematic. As described above, the schematic may be created with ICAD, a software developed by Fujitsu. In other embodiments, schematics created with other types of software may also use an embedded searchable font.

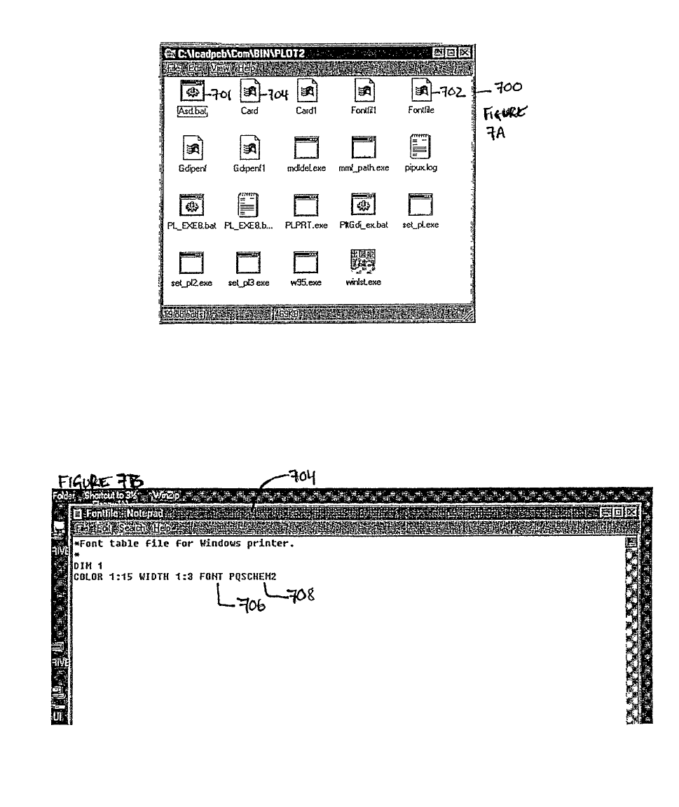

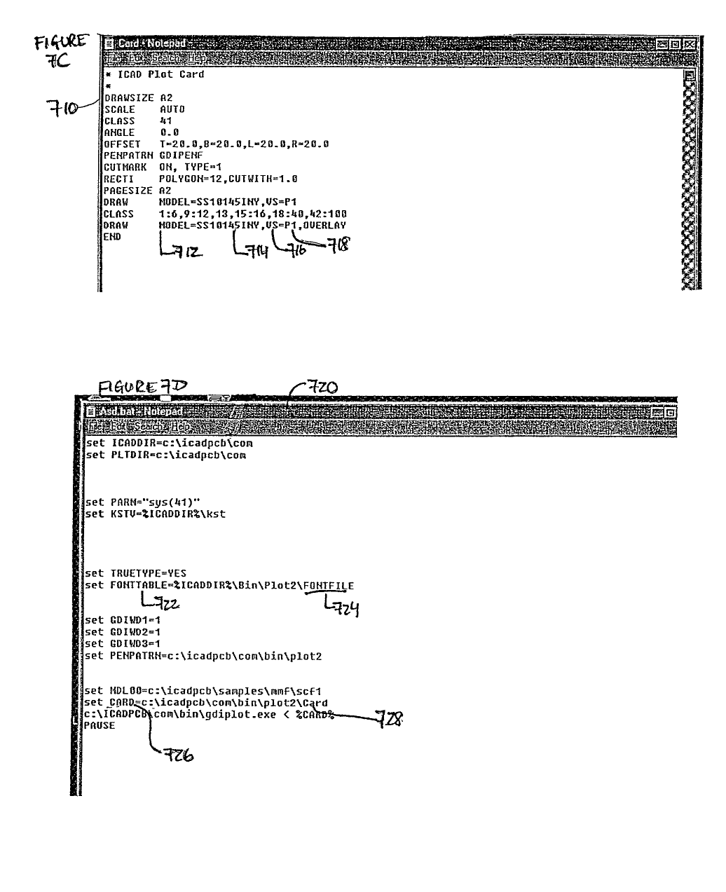

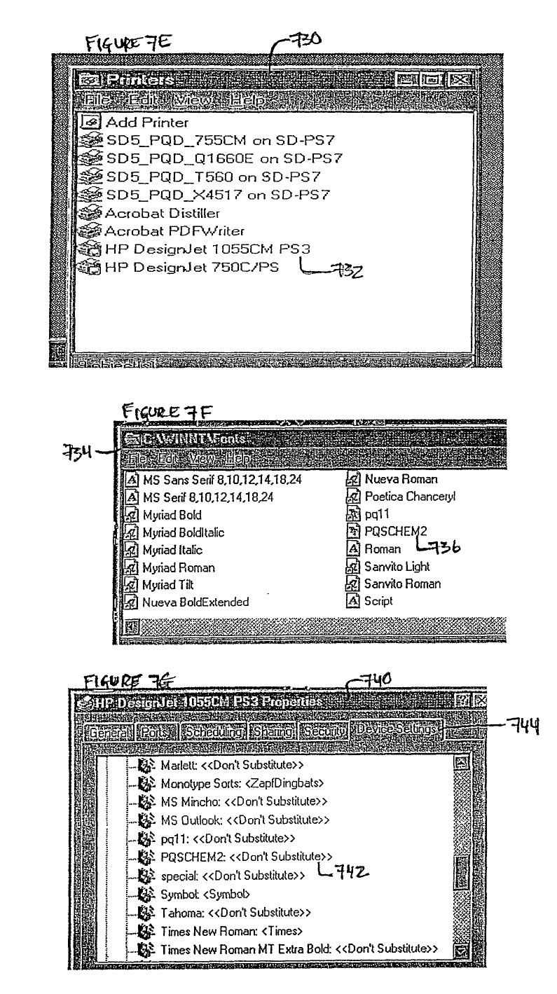

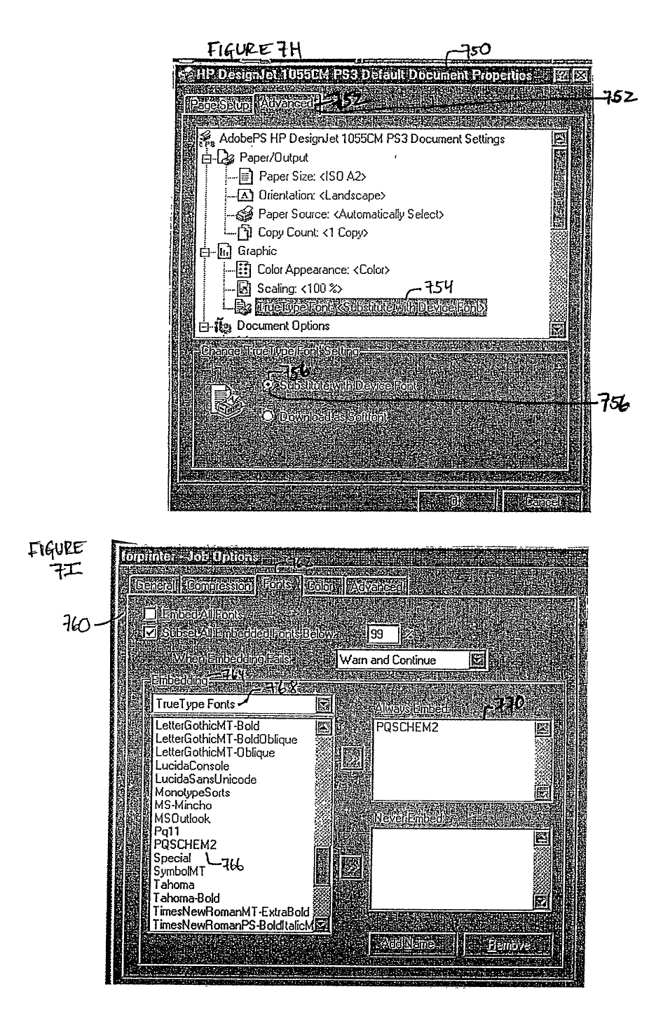

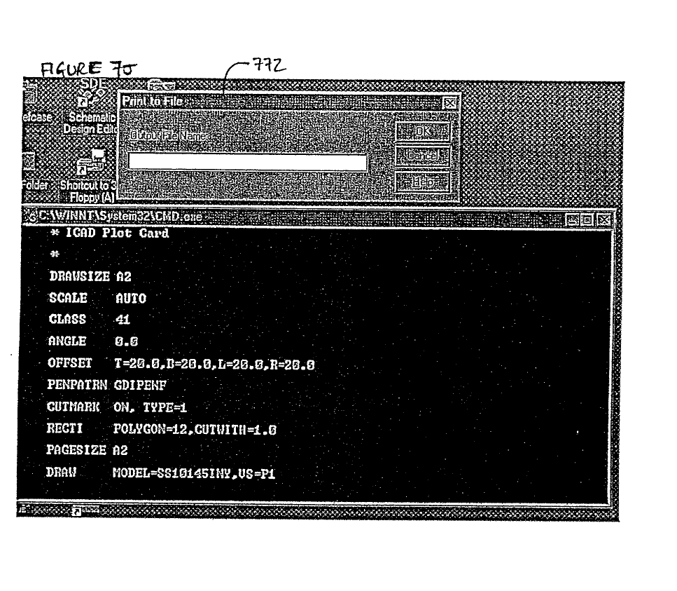

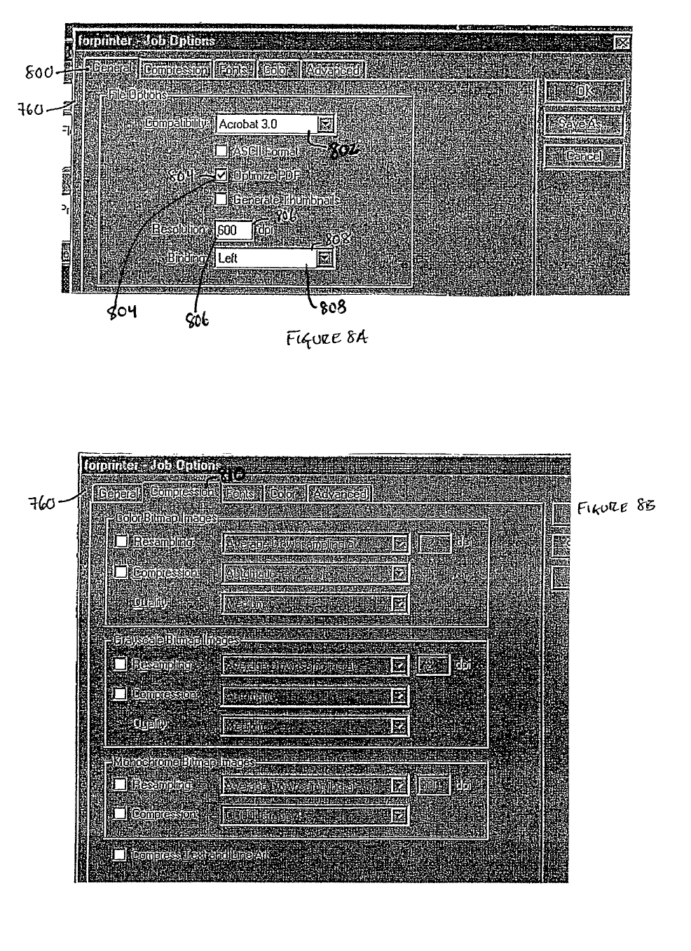

FIGS. 7A-7J illustrate an example of embedding a searchable font, such as the searchable font 200 of FIG. 2, into a prepared schematic. FIGS. 7A-7J illustrate a method that uses ICAD V30L35-00, Windows NT and Adobe Acrobat 3.0 or 4.0. In other embodiments, other types of software and systems may be used to embed a searchable font.

In process block 602 of FIG. 6, the user modifies the CAD software settings to use the searchable font 200 of FIG. 2 for the line art text in the schematic. FIG. 7A illustrates a screen shot of a directory window 700 with a plurality of files used in a CAD software, such as ICAD. In one embodiment, the user accesses the directory window 700 in FIG. 7A through a path ‘C:\CADPCB\Com\Bin\Plot2.’ In FIG. 7A, the user double-clicks on a file icon labeled ‘Fontfile’ 702 to open a Fontfile ‘Notepad’ window 704 shown in FIG. 7B. The user changes the font type that is currently listed to the right of the ‘FONT’ field 706 to ‘PQSCHEM2’ 708, which is one embodiment of the searchable font 200 of FIG. 2. As mentioned above, Courier font 110 (FIG. 1C) or other mono-spaced fonts may be used in accordance with the present invention.

The user closes the Fontfile ‘Notepad’ window 704 and double-clicks on a file icon labeled ‘Card’ 704 in the directory window 700 of FIG. 7A. The software opens a Card Notepad window 710 shown in FIG. 7C. The user inserts the name of a file or schematic 714 after a ‘DRAW MODEL=’ field 712. The user may also specify a page number in the file or schematic 714 with a ‘VS=’ field 716 in FIG. 7C where the software will embed the searchable font 708 (FIG. 7B). For example, a data file for a TV may have 15-20 boards or pages, where some of the pages have schematics and others do not. If the user wants to embed a searchable font in a schematic on page two, the user enters ‘P2’ 718 next to the ‘VS=’ field 716 in FIG. 7C. Thereafter, the user may repeat the method describe herein for each page with a schematic.

In process block 604 of FIG. 6, the user modifies a MS-DOS batch file called ‘asd.bat,’ which is part of the ICAD software. The user double-clicks on a file icon labeled ‘asd.bat’ 701 in the C:\ICADPCB\Com\Bin\Plot2 directory window 700 of FIG. 7A. The user uses an ‘edit’ command to open an asd.bat Notepad window 720 shown in FIG. 7D. The user confirms that a ‘set FONTTABLE=’ field 722 is pointing to FONTFILE 724. If ‘set FONTTABLE=’ field 722 is not pointing to FONTFILE 724, the user changes the ‘set FONTTABLE=’ field 722 to point to FONTFILE 724. The user also confirms that a ‘set CARD=’ field 726 is pointing to the proper directory, which in this example is ‘c:\icadpcb\com\bin\plot2\Card’ 728.

In process block 606 of FIG. 6, the user installs or selects a printer driver (software) to generate a PostScript file based on the computer-generated schematic (e.g., schematic 300 in FIG. 3) with searchable font (e.g., the searchable font 200 in FIG. 2) to be embedded. PostScript is a sophisticated page description language that is used for high-quality printing on laser printers and other high-resolution printing devices. PostScript is capable of describing an entire appearance of a richly-formatted page.

FIG. 7E illustrates a ‘Printers’ window 730 with a plurality of selectable printers. In one embodiment, the user selects a printer driver related to a ‘Hewlett Packard Design Jet Printer 1055CM PostScript (PS) 3’ 732 in FIG. 7E. In other embodiments, the user may select any printer driver that can generate a suitable PostScript file.

In process block 608 of FIG. 6, the user uses a software, such as Adobe Type Manager (ATM), to add or install the searchable font 200 of FIG. 2, e.g., ‘PQSCHEM.ttf,’ into a ‘Font Library’ of a user workstation. Adobe Type Manager is a font utility that enables computer users to display PostScript Type 1 fonts on-screen. PostScript font is a scalable outline font that conforms to Adobe's software specifications for Type 1 fonts, which use a PostScript printer. If ATM is unavailable, the user may place the searchable font 200 of FIG. 2 into a workstation font file. FIG. 7F illustrates a ‘C:\WINNT\Fonts’ window 734 in Windows NT with a plurality of selectable fonts. The user places the searchable font 200, labeled as ‘PQSCHEM2’ 736 in FIG. 7F, into the C:\WINNT\Fonts' window 734.

After a printer driver is selected, the user may open a printer ‘Properties’ window 740 in FIG. 7G that shows the properties of the selected printer 732 in FIG. 7E. In a ‘Device Settings’ file 744, the user may confirm that the ‘PQSCHEM2’ searchable font 742 is properly installed.

The user may open a default document properties window 750 shown in FIG. 7H that shows the default document properties of the selected printer 732 in FIG. 7E. In an “Advanced’ file 752, the user may confirm that a ‘TrueType Font’ field 754 is set to a ‘Substitute with Device Font’ option 756. The user may open a ‘forprinter-Job Options’ window 760 shown in FIG. 7I for the printer selected in FIG. 7E. The user selects a ‘Fonts’ file 762 and selects ‘TrueType Fonts’ 768 in an ‘Embedding’ box 764. The user moves the ‘PQSCHEM2’ searchable font 766 to an ‘Always Embed’ box 770.

In process block 610 of FIG. 6, the user sets a suitable PostScript printer driver, such as the HP Design Jet Printer 1055CM PS 3 732 shown in FIG. 7E, as the default printer to convert the schematic into a PostScript file. The user clicks on an ‘asd.bat’ file icon 701 in the C:\ICADPCB\Com\Bin\Plot2 file 700 in FIG. 7A. The software opens a ‘Print to File’ window 772 as shown in FIG. 7J. The user may enter any name followed by a ‘.ps,’ such as ‘c:\temp\test.ps,’ to convert the ICAD schematic to a PostScript file.

In a block 612 of FIG. 6, the user locates the ‘.ps’ file according to the location specified by the user in block 612 (e.g., C drive, ‘temp’ directory, file name ‘test.ps’) and clicks on the ‘.ps’ file. Adobe Distiller opens and converts the PostScript ‘.ps’ file into a PDF file with embedded ‘PQSCHEM2’ searchable font. After a PDF file is created for the schematic with ‘PQSCHEM2’ searchable font, the user who created the file or other users may print the PDF file or view the PDF file on-screen.

In other embodiments, the process blocks 600-612 in FIG. 6 may be performed in an order that is different than the order shown in FIG. 6.

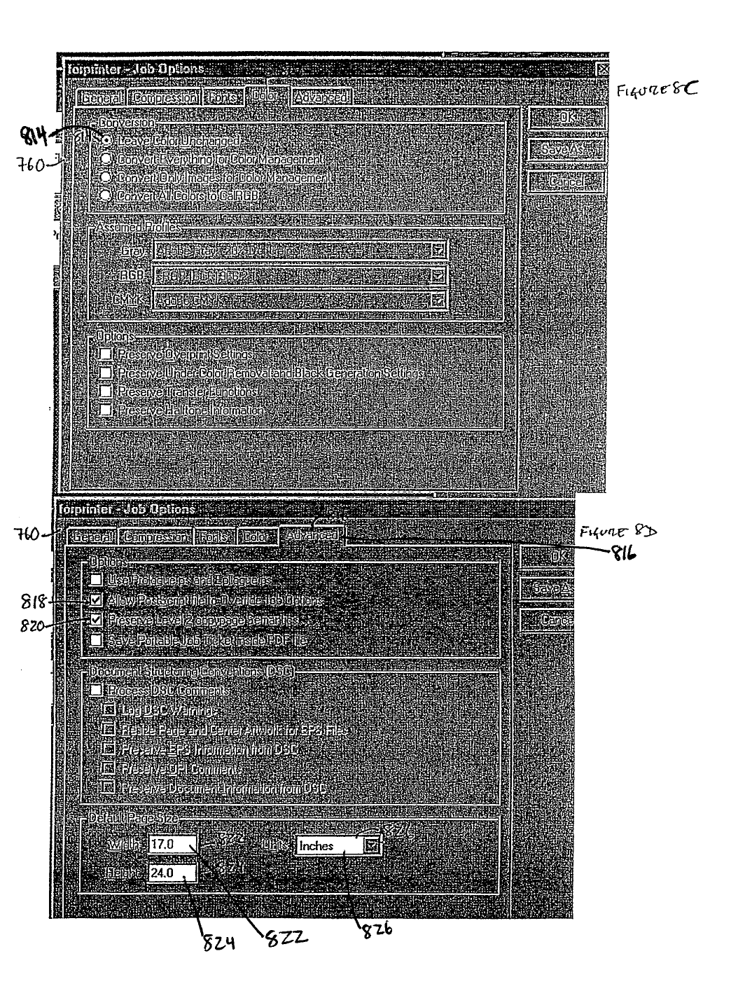

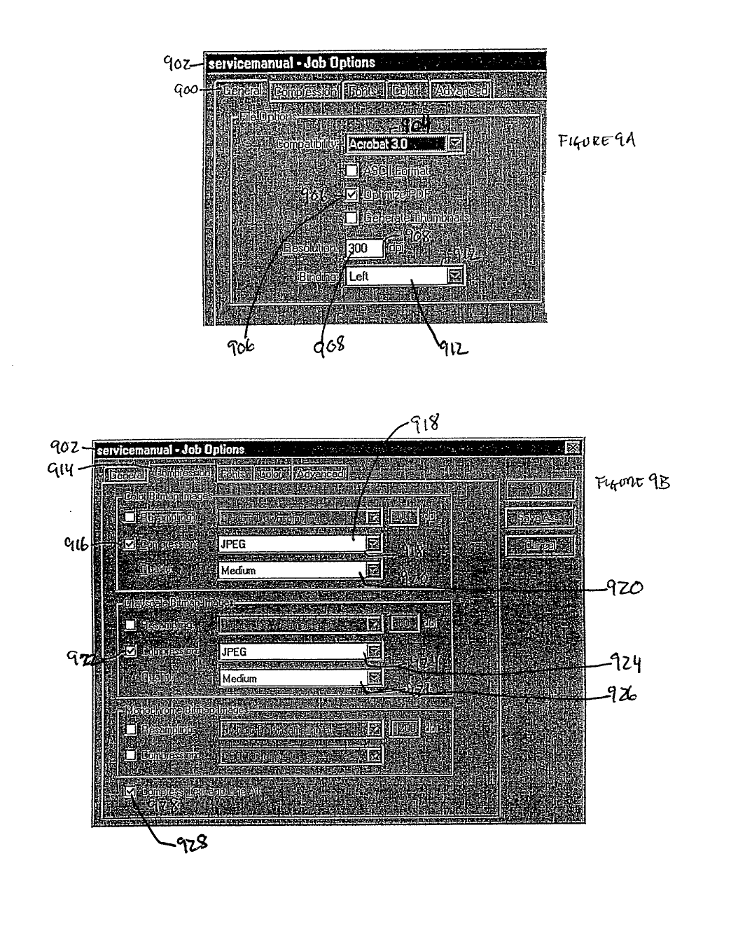

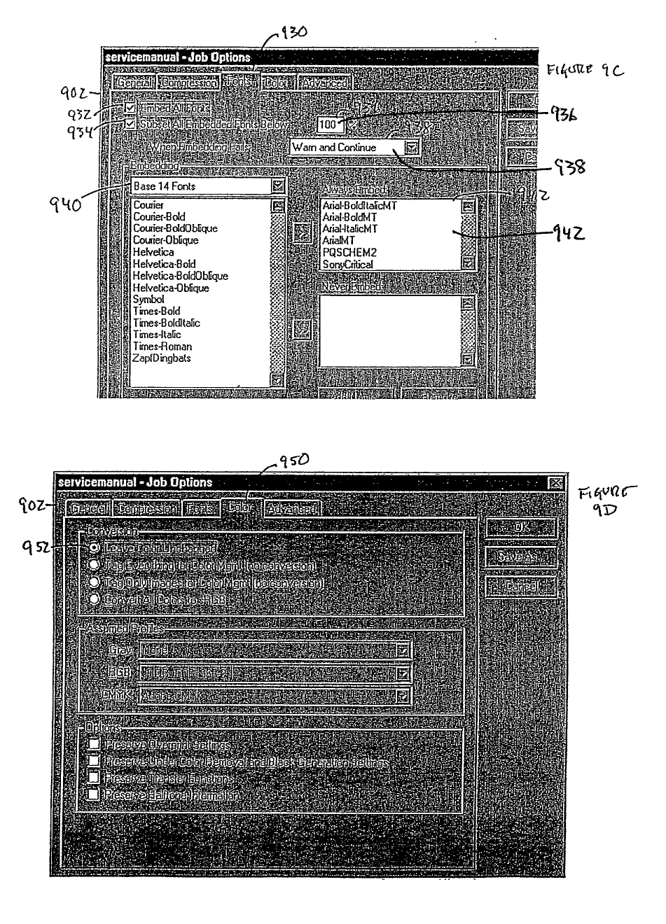

FIGS. 8A-8D illustrate exemplifying configurable settings for a printer driver to configure a .ps file with embedded searchable font 200 (FIG. 2) for printing. FIG. 8A illustrates a plurality of configurable parameters in a ‘General’ file 800 of the ‘forprinter-Job Options’ window 760 shown in FIG. 7I. In FIG. 8A, the user may set a ‘Compatibility’ box 802 to ‘Acrobat 3.0’ or ‘4.0.’ The user may check an ‘Optimize PDF’ box 804. The user may set a ‘Resolution’ box 806 to ‘600.’ The user may set a ‘Binding’ box 808 to ‘Left.’

FIG. 8B illustrates a plurality of configurable parameters in a ‘Compression’ file 810 of the ‘forprinter-Job Options’ window 760 shown in FIG. 7I. In FIG. 8B, the user may not desire any compression for printed schematics in order to preserve a high resolution.

FIG. 8C illustrates a plurality of configurable parameters in a ‘Color’ file 812 of the ‘forprinter-Job Options’ window 760 shown in FIG. 7I. In FIG. 8C, the user may check a ‘Leave Color Unchanged’ box 814.

FIG. 8D illustrates a plurality of configurable parameters in an ‘Advanced’ file 816 of the ‘forprinter-Job Options’ window 760 shown in FIG. 7I. In FIG. 8D, the user may check an ‘Allow PostScript file to Override Job Options’ box 818 and a ‘Preserve Level 2 copypage Semantics’ box 820. The user may set a ‘Width’ box 822 to ‘17.0,’ a ‘Height’ box 824 to ‘24.0’ and ‘Units’ box 826 to ‘Inches.’

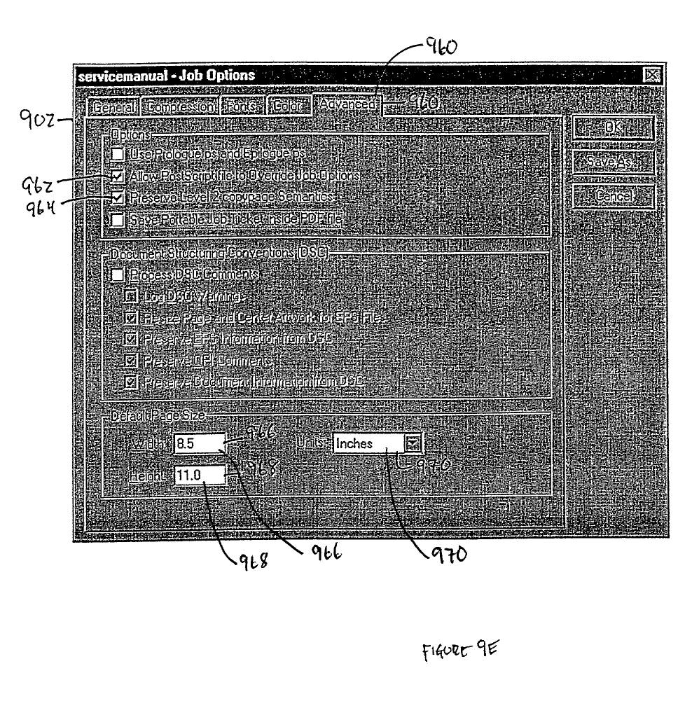

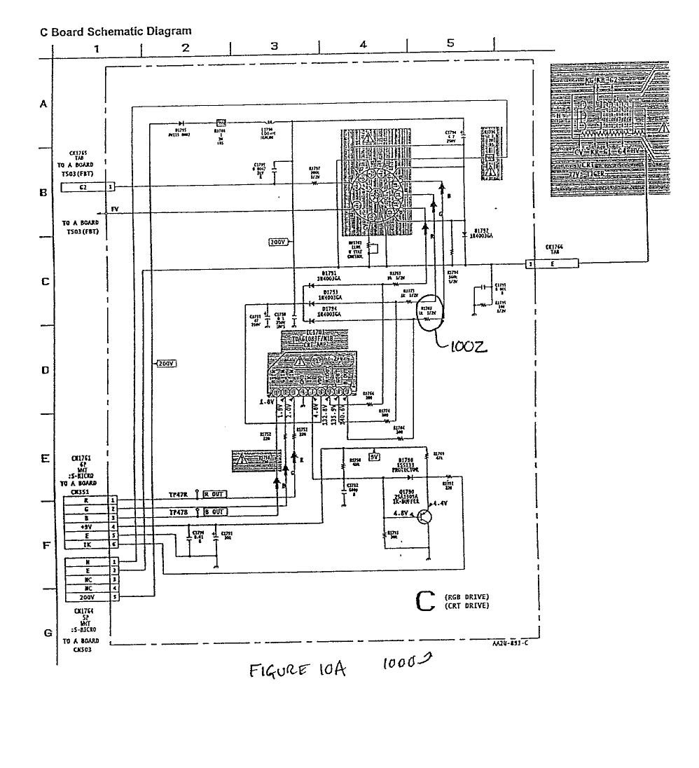

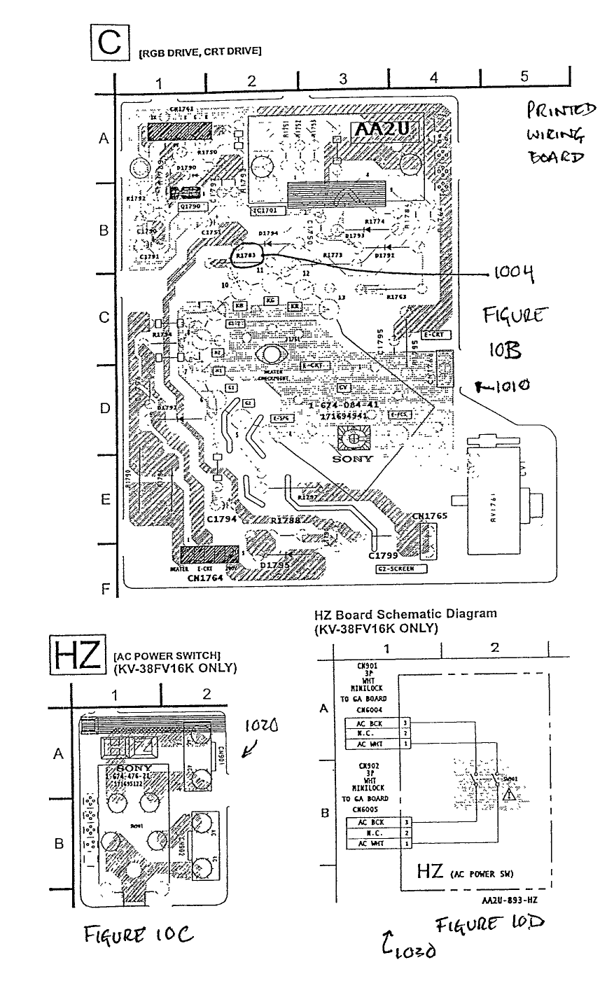

FIGS. 9A-9E illustrate exemplifying configurable settings for a printer driver to configure a .ps file with embedded searchable font 200 (FIG. 2) for on-screen viewing. The .ps file may be transmitted via the Internet or an Ethernet to a plurality of users at various locations.

FIG. 9A illustrates a plurality of configurable parameters in a ‘General’ file 900 of a ‘servicemanual-Job Options’ window 902. In FIG. 9A, the user may set a ‘Compatibility’ box 904 to ‘Acrobat 3.0’ or ‘4.0.’ The user may check an ‘Optimize PDF’ box 906. The user may set a ‘Resolution’ box 908 to ‘300.’ The user may set a ‘Binding’ box 912 to ‘Left.’

FIG. 9B illustrates a plurality of configurable parameters in a ‘Compression’ file 914 of the ‘servicemanual-Job Options’ window 902. In FIG. 9B, the user may check a ‘Color Bitmap Images Compression’ box 916 and a ‘Grayscale Bitmap Images Compression’ box 922. The user may select ‘JPEG’ as the type of compression in boxes 918, 924 and specify ‘Medium’ in ‘Quality’ boxes 920, 926. The user may also check a ‘Compress Text and Line Art’ box 928.

FIG. 9C illustrates a plurality of configurable parameters in a ‘Fonts’ file 930 of the ‘servicemanual-Job Options’ window 902. In FIG. 9C, the user may check an ‘Embed All Fonts’ box 932 and a ‘Subset All Embedded Fonts Below’ box 934. The user may select ‘100%’ in a box 936 and a ‘Warn and Continue’ option in a ‘When Embedding Fails’ box 938. The user may select ‘Base 14 Fonts’ in an ‘Embedding’ box 940 and a plurality of font types in an ‘Always Embed’ box 942.

FIG. 9D illustrates a plurality of configurable parameters in a ‘Color’ file 950 of the ‘servicemanual-Job Options’ window 902. In FIG. 9D, the user may check a ‘Leave Color Unchanged’ box 952.

FIG. 9E illustrates a plurality of configurable parameters in an ‘Advanced’ file 960 of the ‘servicemanual-Job Options’ window 902. In FIG. 9E, the user may check an ‘Allow PostScript file to Override Job Options’ box 962 and a ‘Preserve Level 2 copypage Semantics’ box 964. The user may set a ‘Width’ box 966 to ‘8.5,’ a ‘Height’ box 968 to ‘11.0’ and a ‘Units’ box 970 to ‘Inches.’

Using A Schematic With Embedded Searchable Font

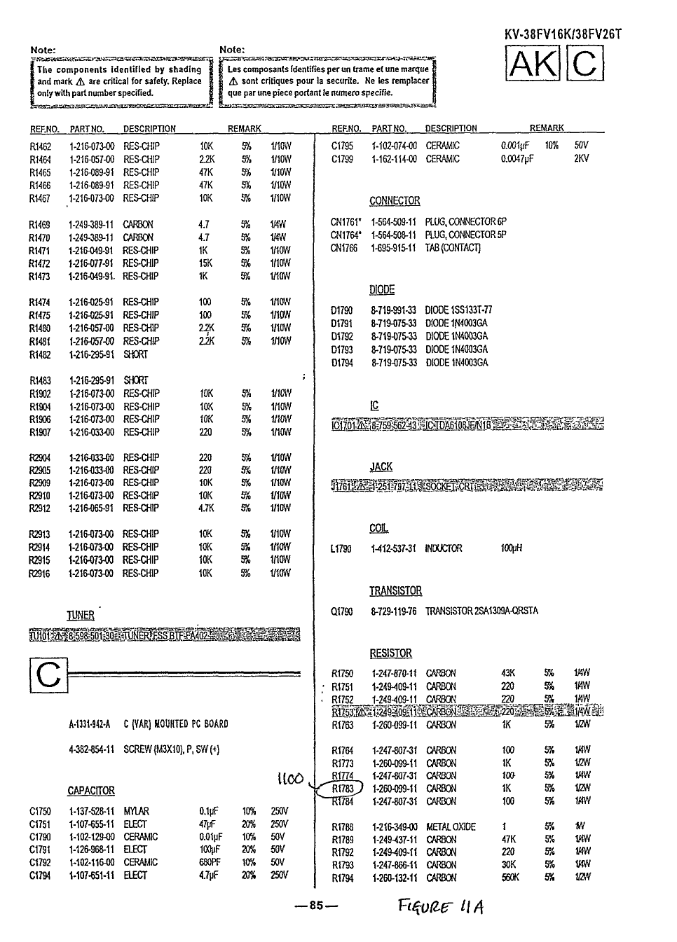

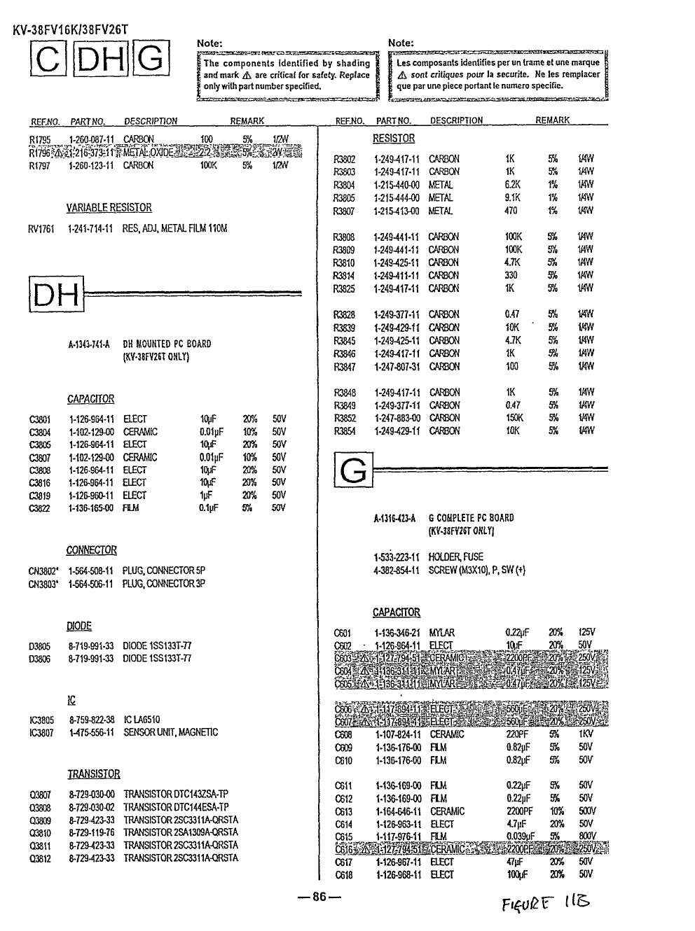

FIGS. 10A-10D illustrate exemplifying PDF schematics that may be included in a document, such as a service manual for a device. The schematics in FIGS. 10A-10D may be on the same page or on different pages in a software such as Adobe Acrobat Reader 3.0 or 4.0. FIG. 10A illustrates an exemplifying board schematic diagram 1000 for a device. FIG. 10B illustrates an exemplifying printed wiring board (PWB) schematic 1010 related to the board schematic diagram 1000 of FIG. 10A. FIGS. 10C illustrates an exemplifying schematic 1020 of a power switch related to the board schematic diagram 1000 of FIG. 10A. FIG. 10D illustrates another exemplifying schematic 1030 of the switch in FIG. 10C.

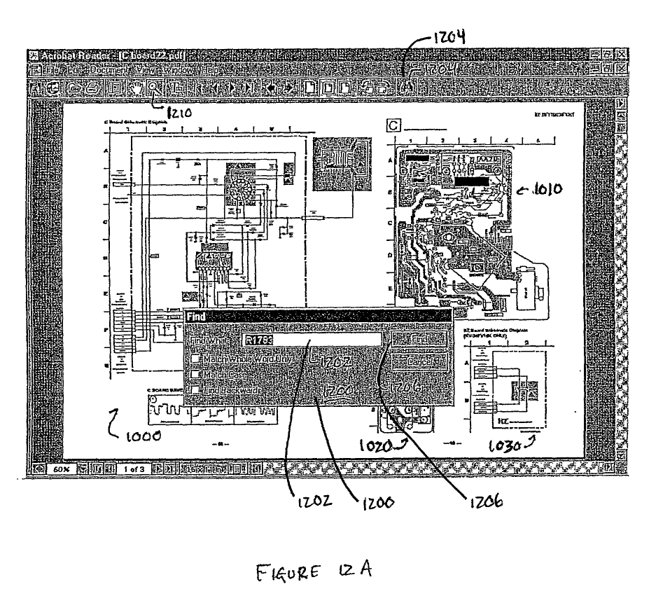

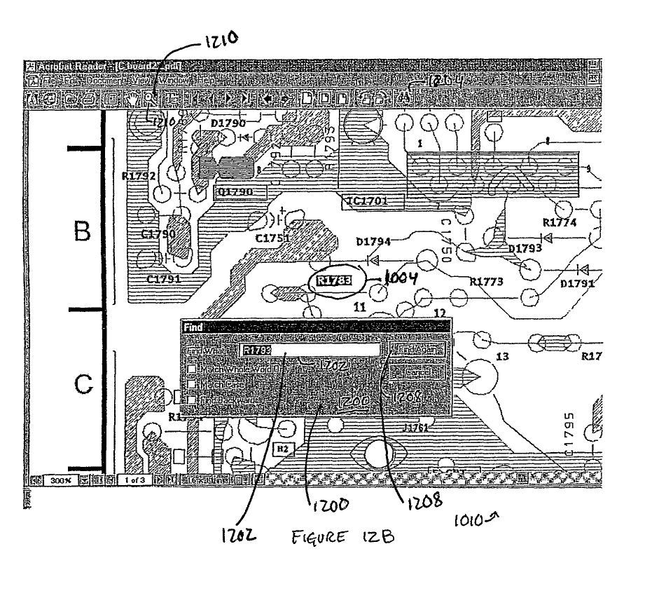

FIGS. 11A-11B illustrate exemplifying lists of parts in FIGS. 10A-10D. The schematics in FIGS. 10A-10D and the parts lists in FIGS. 11A-11B may be on separate pages spread throughout a service manual. Users, such as service technicians, may spend a lot of time trying to manually find particular components and cross-reference the components between schematics (FIGS. 10A-10D) and parts lists (FIGS. 11A-11B) on a computer or with hard copy manuals. Moreover, users may have to repeatedly zoom in and zoom out of schematics to see particular components and how they function with other components.

With a searchable font according to the present invention, users can quickly cross-reference text in one schematic on a computer, such as a desktop, a lap top, a kiosk or a PDA, with text in other schematics. This cross-referencing feature is particularly useful if there are several schematics spread throughout a document, and each schematic has a large number of parts or circuit components.

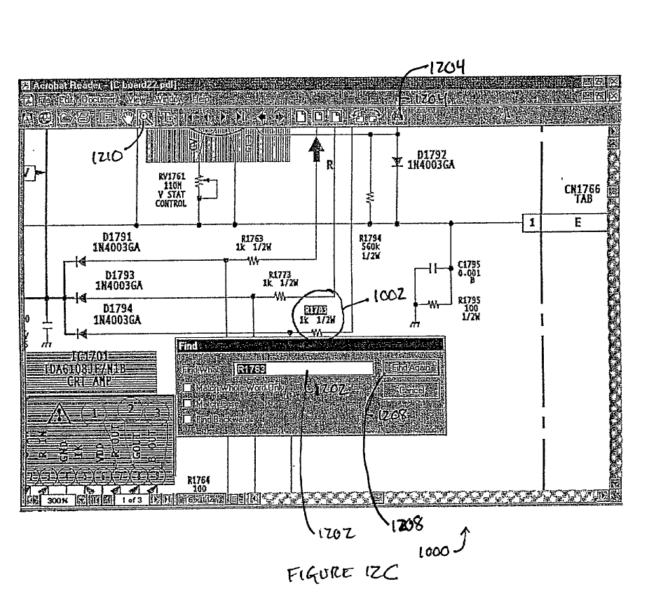

FIGS. 12A-12C illustrate an example of using a searchable font in the PDF schematics of FIGS. 10A-10D. FIG. 12A is a composite view of the schematics of FIGS. 10A-10D. If a user wants to find a particular component in the schematics of FIGS. 10A-10D, the user presses <Ctrl><F> on a keyboard or clicks on a Find icon 1204 (shaped as binoculars) near the top of the screen in Adobe Acrobat Reader to open a ‘Find’ box 1200 (FIG. 12A). The user enters the name of a component, such as a resistor ‘R1783,’ in the search field 1202 and clicks on the ‘Find’ button 1206 or presses <Enter>. If the schematics 1000, 1010, 1020, 1030 in FIGS. 10A-10D are configured with a searchable font as described above, Acrobat Reader automatically finds and highlights the first occurrence of resistor ‘R1783’ in FIG. 12A, which is shown as ‘R1783’ 1004 in FIG. 10B. The user may click on a zoom icon 1210 (shaped as a magnifying glass) near the top of the screen in Acrobat Reader and click on the ‘R1783’ 1004 to zoom in on ‘R1783’ 1004, as shown in FIG. 12B.

If the user presses <Ctrl><F> on a keyboard or clicks on the Find icon 1204 (FIG. 12B) again, the ‘Find’ box 1200 opens again with a ‘Find Again’ button 1208. If the user clicks on the ‘Find Again’ button 1208, Acrobat Reader automatically finds the next occurrence of ‘R1783,’ which is shown as ‘R1783’ 1002 in FIGS. 10A and 12C.

If the user presses <Ctrl><F> on a keyboard or clicks on the Find icon 1204 (FIG. 12C) again, the ‘Find’ box 1200 opens again with a ‘Find Again’ button 1208. If the user clicks on the ‘Find Again’ button 1208, Acrobat Reader automatically finds the next occurrence of ‘R1783,’ which is shown as ‘R1783’ 1100 in FIG. 11A. This assumes that the lists in FIGS. 11A-11B are in the same PDF document as the schematics 1000, 1010, 1020, 1030 in FIGS. 10A-10D and that the lists in FIGS. 11A-11B are configured with a searchable font as described above.

Thus, the user can quickly and automatically ‘jump’ from one schematic 1010 (FIGS. 10B and 12B) to another schematic 1000 (FIGS. 10A and 12C) to a parts list in FIGS. 11A-11B without manually searching for a component.

In addition, engineers can easily change, update and distribute schematics with searchable font, such as engineering drawings, to manufacturers and service personnel. For example, engineers often create a ‘master’ schematic that covers a plurality of product models, some of which will be marketed and some will not be marketed. Once the engineers know which product model(s) will be marketed, the engineers can use the searchable font 200 to quickly find components in the master schematic to change or delete to match the specifications of product model(s) to be marketed.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. A method of using a searchable font, the method comprising:
accessing a schematic with line art text using a first software operating at a first computer; and
embedding a mono-spaced font into the line art text in the schematic and electronically converting the schematic into a Portable Document Format file, wherein the mono-spaced font in the Portable Document Format file is configured to be electronically searchable by users using a second software.

2. The method of claim 1, wherein the first software is a computer-aided design program.

3. The method of claim 1, wherein the first software is Integrated Computer Aided Design.

4. The method of claim 1, wherein the second software is Adobe Acrobat Reader.

5. The method of claim 1, wherein Adobe Distiller converts the schematic into a Portable Document Format file.

6. The method of claim 1, wherein a computer-aided design software, a PostScript printer driver and Adobe Distiller embeds the mono-spaced font into line art text in the schematic.

7. The method of claim 6, wherein the PostScript printer driver generates a PostScript file based on the schematic with embedded mono-spaced font, and the Adobe Distiller converts the PostScript file into a Portable Document Format file.

8. The method of claim 1, wherein the mono-spaced font is Courier font.

9. The method of claim 1, wherein the mono-spaced font is taller than Courier font.

10. The method of claim 1, wherein the mono-spaced font is thicker than Courier font.

11. The method of claim 1, wherein the mono-spaced font is narrower than Courier font.

12. The method of claim 1, wherein spacing between letters of the mono-spaced font is narrower than spacing between letters of Courier font.

13. The method of claim 1, further comprising transferring the Portable Document Format file from the first computer to a second computer, the second computer being configured to allow a user to use the second software to electronically search for the mono-spaced font in the schematic.

14. The method of claim 13, wherein the first computer transfers the Portable Document Format file to the second computer via the Internet.

15. The method of claim 13, wherein the first computer transfers the Portable Document Format file to the second computer via an Ethernet.

16. The method of claim 1, further comprising configuring the first software in the first computer to use the mono-spaced font.

17. The method of claim 1, wherein the schematic is a circuit diagram.

18. The method of claim 1, wherein the schematic is a printed wiring diagram.

19. The method of claim 1, wherein the schematic is a list of components.

20. A system for embedding a searchable font, the system comprising:
a first software operating at a first computer, the first software being configured to create a schematic with line art text; and
a second software operating at the first computer, the second software being configured to electronically convert the schematic into a Portable Document Format file and embed a mono-spaced font into the line art text in the schematic, wherein the mono-spaced font in the schematic is configured to be electronically searchable by at least one user.

21. The system of claim 20, wherein the schematic is configured to be electronically searchable by at least one user at a second computer.
